(19) United States
(12) Patent Application Publication
(10) Pub. No.: US 2004/0226895 A1
(43) Pub. Date: Nov. 18, 2004

(54) Animal waste treatment system with reusable recovered water and solids

(76) Inventor: David Bromley, West Vancouver (CA)

Correspondence Address: ROBERT J. SCHAAP, Suite 188, 21241 Ventura Boulevard, Woodland Hills, CA, 91364, US

(21) Appl. No.: 10/846,392

(22) Filed: May 13, 2004

Related U.S. Application Data
(60) Provisional application No. 60/470,480, filed on May 13, 2003.

(51) Int. Cl. C02F 1/00

(52) U.S. Cl. 210/768; 210/202; 210/806

(57) ABSTRACT

A high content recovery system which allows for the processing of animal waste and the reuse of the nutrient rich solids and water used in the processing of such animal waste. The recovery system includes a solids concentrator section which concentrates solids and aids in removal of the liquids, a liquid treatment section which treats the water in such manner to allow the same to be reused as potable water and an organic waste processing area. The system is efficient in using substantial portions of the animal waste, both as the nutrient rich solids for fertilizer and other applications and reuse of the water for further processing and other uses and thus effectively constitutes a zero waste discharge system.

### RELATED APPLICATIONS

This application is based on and claims for priority the filing date of my U.S. Provisional patent application Ser. No. 60/470,480, filed May 13, 2003 for Zero Waste Discharge System with Reusable Recovered Water and Solids.

### BACKGROUND OF THE INVENTION

1. Field of the Invention

This invention relates in general to certain new and useful improvements in a water and animal waste solids recovery system in which both the solids and the water can be further processed and used and, more particularly, to an animal waste recovery and processing system in which a substantial portion of the nutrient rich solids can be captured, treated and reused and in which the water used in the processing of these solids can also be recaptured, treated and reused with very little waste product, if any at all, not being reused.

2. Brief Description of Related Art

In recent years and particularly with emphasis on environmental concerns, the processing of animal waste has become a significant issue. In many animal farming operations, such as with pigs and cattle, there is a substantial amount of animal waste which must be discarded. In many cases and particularly with certain animals as, for example, pigs, the animal waste has a high percentage of phosphorus and nitrogen. The excessive percentages of these components in the animal waste militates against the use of these animal wastes as other resources as, for example, fertilizer and the like, at the very least without significant and costly further processing. Exemplary is the fact that the high percentage of the phosphorus can literally cause burning of other plant growth if the untreated animal waste were used as a fertilizer product.

As a result of the need for processing of animal waste, there have been several proposed animal waste treatment systems. However, these treatment systems largely deal with treatment of one or a few components in the waste product which causes a particular problem. Thus, there are several waste treatment systems which have been designed to focus on filtering of the liquids, and there are other systems which have been designed to potentially remove or reduce the phosphorus, and the like from the solids. However, these treatment systems also have byproducts which can be environmentally harmful. More importantly, there has been no real treatment system which deals with all portions of the animal waste such that there is a zero discharge of any waste product which could be reused and which allows for treatment and reuse of water in the processing thereof.

One of the very common systems currently in use is that of holding the waste water from barns in a storage tank or a lagoon and, thereafter, applying the contents of this tank or lagoon to a fairly large land mass, on periodic intervals as, for example, once or a few times per year. Inasmuch as the animal waste or the processing water may have a substantial phosphorus or nitrogen content, the size of the land base on which the contents in the storage are dispersed must be sufficient to enable the ground surface to handle the high content of phosphorus and nitrogen in the waste water and solids. As a result, land base requirements can be high. The need for the extra amount of land to disperse the water is costly, thereby adding to the cost of any animal farming operation. Moreover, it eliminates the use of valuable land for other purposes. Depletion of the phosphorus content alone in waste water to be applied to the land base can reduce the amount of land base which is required for this purpose.

In my co-pending U.S. Provisional patent application Ser. No. 60/512,574, filed Feb. 5, 2004, I have set forth a system which relies upon the use of a reaction zone at the lower portion of a clarifier. This system relies upon a pre-treatment in which the waste water containing animal feces is mixed with a destabilizing agent, such as aluminum sulfate or the like, and thereafter is introduced into a clarifier. The construction of the clarifier allows for the settling of a substantial quantity of the solids materials contained in the water. The clarifier is constructed so that the waste water with a substantial portion of the solids removed therefrom pours over an upper portion thereof and into a filter for further depletion of the phosphorus content. Although this system is effective in phosphorus removal, it is limited in the amount of nitrogen which can be depleted from the water. As a result, the waste water still contains a moderately high nitrogen content.

In other systems, filtration is employed, although the filtration systems can be costly to construct and operate for management of large volumes of solids. These filtration systems often employ relatively costly membrane filters. Nevertheless, systems of this type are not only costly to use, they suffer from a lack of efficiency. Although they can be effective for recovering the water and segregating nutrients for uses as a fertilizer, the cost of use militates against their use.

Other waste systems have relied upon biological treatment in which a microbiological culture (known as a biomass) is developed in a reaction zone to convert phosphorus and/or nitrogen and/or organic materials. However, systems of this type require frequent maintenance, manual monitoring and control of the operating parameters, as well as frequent cleaning of the filter media. Since the organic content in the waste stream is high, large biomass volumes occur which increases solid volumes to be managed. Moreover, this type of system is very sensitive and consistently high phosphorus content is difficult to process.

Inasmuch as there has been a high cost associated with the treatment of animal waste, there have been many governmental regulations to control the use and disposition of animal waste. As with environmental controls generally, these controls are frequently treated with indifference and with only an absolute minimum of compliance. Given the high cost of the treatment of animal waste, enforcement programs have also been developed to require tighter compliance with all environmental protection regulations.

It would be desirable to provide a treatment system for the treatment of animal waste in which the water can be recovered and reused and in which the nutrients contained in the solids could also be reused, all at a relatively low cost.

### OBJECTS OF THE INVENTION

It is, therefore, one of the primary objects of the present invention to provide an animal waste treatment system which enables the generation of reusable water and which also enables the recovery of nutrient rich solids and all of which have further utility.

It is another object of the present invention to provide an animal waste treatment system of the type stated which is highly efficient in operation and which can reduce the impurity content in the water to a level where it can be reused or remixed with other potable or fresh water and reused.

It is a further object of the present invention to provide an animal waste treatment system of the type stated which enables the recovery of nutrient rich solids with sufficiently reduced nitrogen and phosphorus contents, such that the solids are capable of being reused as, for example, in synthetic fertilizer operations.

It is an additional object of the present invention to provide an animal waste treatment system in which waste water can be processed so that it can be usable as wash water, flush water and even irrigation water, as well as cooling water and in other applications in which too high an impurity content would prohibit its use.

It is another salient object of the present invention to provide a method of recovery of animal waste and recovery of the water used in the animal waste treatment operation, as well as recovery of nutrient rich solids on a highly efficient basis and at a relatively low cost.

With the above and other objects in view, my invention resides in the novel features of form, construction, arrangement and combination of parts and components presently described and pointed out in the claims.

### SUMMARY OF THE INVENTION

The invention provides an animal waste treatment and disposal system, which is designed for optimum recovery of liquids, primarily water, used in the recovery process and nutrient rich solids from the animal waste.

The system of this invention has three major sections or sub-systems. The first of these sub-systems is a solids concentrator which is designed to cause a separation of the liquid from the solid material and allow for delivery of the solid materials to a solid storage and the delivery of the recovered liquid, or water, to a liquid treatment system. The second major sub-system is the liquid treatment system which is designed to remove both the high nitrogen content and the high phosphorus content from the liquid thereby allowing the water to be used for purposes which would have been prohibited by virtue of the high nitrogen or high phosphorus content. The third major sub-system is an organic processing area in which the waste water is stored in a pond or similar area and where decomposition of one or more of the ingredients will occur so that the water is usable for spraying or other application.

In the treatment of the animal waste, water, usually from a fresh water source, is added to the animal waste material primarily for purposes of partially dissolving the animal waste solids and moving the same to a location where it can be further treated. Thus, when water is added, the animal waste becomes entrained in the water in the form of a waste water/sludge combination.

In the first stage of the water/solid separation process, there is initially provided a coarse screen in which the coarse solids are allowed to fall to a collection area where these solids can then be introduced into a solids storage area. Thereafter, the primary component in the solids concentrator is a clarifier or so-called “thickener” which provides a coarse separation of the solids from the liquids. The separated solids are conveyed to a screw press or like device which allows for further removal from the waste solids.

A nutrient recovery unit is also associated with this solids recovery and allows for the recovery of the nutrients obtained in the water entrained animal waste. These nutrients typically contain matter with a high phosphorus content and, at least to some extent, a substantial nitrogen content. Therefore, in the initial solids recovery, a portion of the phosphorus and the nitrogen is actually absorbed by the water and removed from the animal waste. Phosphorus and nitrogen which are not separated from the solids do not fully enter the water and become entrained in the water.

The separated solids can be returned to the head end of the clarifier, resulting in a concentration of nutrient containing solids and, particularly, phosphorus containing solids which are recovered in the solid recovery unit. These solids, although still having a moisture content of sixty to eighty percent are considered consistent with “dry transportable solids” and these solids have a high phosphorus content as well as substantial nitrogen and potassium content. Typically, these nutrients are frequently not removed from the solids and therefore remain in the solids allowing for these recovered solids to be a valuable product useful as a substitute for fertilizer.

A preferred clarifier which is used in the system of the invention permits the introduction of the waste water carrying the solid animal waste at the lower end thereof. The clarifier also contains a plurality of generally parallel inclined baffles, such that, as the level of waste water within the clarifier is raised, the animal waste impinges on baffle plates in the clarifier and the solids are allowed to settle to the bottom of the clarifier. A large quantity of the phosphorus and a substantial quantity of the nitrogen normally entrained in the water remains deposited with the deposited animal waste. This allows the animal wastes having the high phosphorus content and the nitrogen and potassium contents to be useful as other products.

The water from the clarifier is introduced into a liquid treatment system which largely relies upon clarification and filtration. Some disinfection can also be used, if desired. The filter used will further process the waste water and permit the removal of fine suspended solids, which may contain the phosphorus and nitrogen and, for that matter, the potassium. The inclined baffle clarifier of the type described in the aforesaid co-pending U.S. Provisional patent application Ser. No. 60/512,574, filed Feb. 5, 2004, has been found to be highly effective for this purpose. However, any clarifier designed for separation of the water and the solids could be used. For that matter, any conventional filter may also be used for this purpose.

The water which exits the filtration treatment may then be introduced into a containment structure. Actually, there are several potential uses for the water which has been filtered and clarified. Some of that water may be reintroduced into the barn for cleaning or cooling of the barn and/or the animals or used in other applications, e.g. cooling towers. This water can also be used as backwash water and introduced into the main clarifier for further operation. Further, the treated water can also be added to the animal waste for movement of the waste from the barn to the clarifier. In addition, the treatment water can be blended with fresh water, such as water from the ground water sources, and where the blend provides acceptable parameters for potable water or drinking water for the animals. In other words, the treated water is not merely a waste but can be used to carry out additional utilitarian functions.

The water which is retained in the pond can be temporarily held and used for irrigation in any location. However, the water is primarily used to treat an area surrounding the pond, such as grass on the area surrounding the pond. Inasmuch as the phosphorus content has been substantially reduced, the water can be sprayed much more frequently than it might otherwise be able to be sprayed. As an example, the water can be sprayed almost daily to moisture saturation levels in the upper 75-150 mm, without damaging the growth of a grass crop. This growth of a grass crop actually promotes evaporation/transpiration including nitrogen uptake. Further, microbiological cultures in soil will convert excess organics and nitrogen to components of the nitrogen gas, carbon dioxide and water. Thus, the otherwise large surface area which might be required to dispel the collected water can readily be avoided. This allows animal farmers to maintain a substantially reduced surface area for dispelling the collected water and which, in turn, reduces the cost of processing the animal waste.

This present invention thereby provides a unique and novel animal waste disposal system which allows for the regeneration and reuse of water, as well as the collection and reuse of nutrient rich solids. The invention also allows a complete reuse of all solids and water so that there is zero discharge from the processing. In other words, nothing is wasted.

This invention also possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawing (one sheet) in which:

FIG. 1 is a schematic flow diagram, showing the process and the overall components used in the system of treating and disposing of animal waste.

### DETAILED DESCRIPTION OF A PREFERRED EMBODIMENT

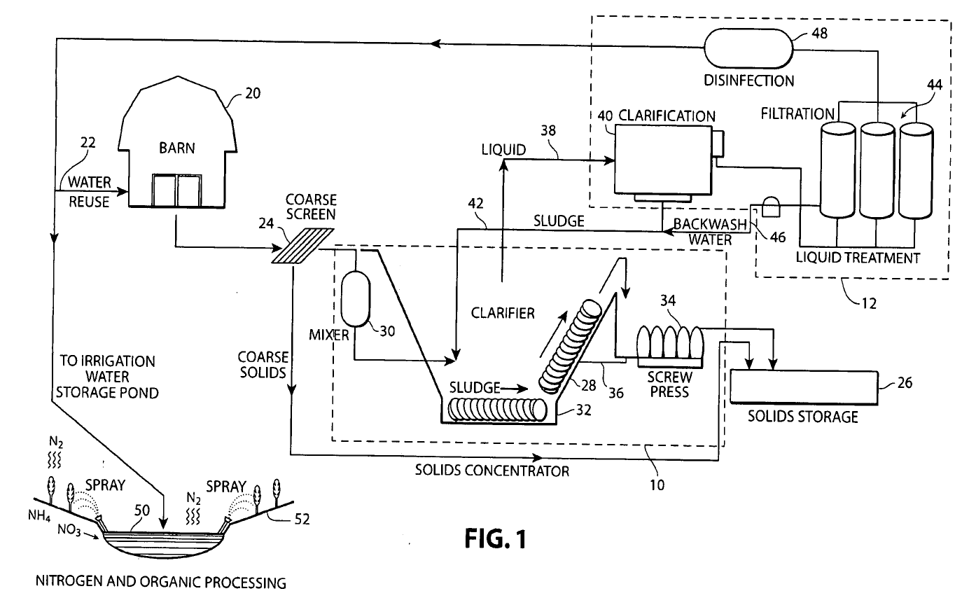

Referring now in more detail and by reference characters to the drawing which illustrates a preferred embodiment of the present invention, FIG. 1 illustrates the overall processing and major sub-systems used in the waste treatment system of the present invention. In particular, this waste treatment system provides for the treatment of both the solid contents which may contain reusable nutrients and the water carrying the animal waste so that the latter may also be reclaimed for non-potable industrial reuse.

In particular, the system of the invention as shown in FIG. 1 comprises three major sub-systems which include a solids concentration system 10, a liquid treatment system 12 and an organic processing station 14. These systems are hereinafter described in more detail.

In animal farming operations, the animals, such as pigs and the like, are frequently located in a generally confined area. Moreover, at night time they are frequently housed in a barn 20. In this case, there are frequently grates and the like allowing for animal urine and animal solid waste to be deposited into a trough where the latter can be washed for removal. It should be understood that the barn 20 is only representative of the numerous types of animal waste collection areas.

For purposes of washing the animal waste from the barn or other area, a water source 22 may be provided. In the embodiment as shown in FIG. 1, the water source 22 is illustrated as being retreated and reused water, it being understood that any source of water, including fresh water, or potable water, could be used for this purpose.

The animal waste entrained in the water stream is then passed through a coarse screen 24 in which the coarse solids are separated from the water allowing the solids to be deposited in a trough and thereafter removed to a solids storage area 26. However, the remaining portion of the solids still entrained in the water is delivered to a solids concentrator sub-system 10 and, particularly, a clarifier 28 in that solids concentrator sub-system 10. Prior to introduction into the clarifier 28, the waste carrying liquid stream is introduced into a mixer 30 where a coagulating agent, such as aluminum sulfate is added and mixed with the waste carrying water stream. This will aid in separation of the solids from the water and in the cleansing of the water.

The clarifier which is preferably used is that dual stage clarifier described and illustrated in the aforesaid co-pending U.S. provisional patent application. However, other clarifiers could be used. For that matter, any of a number of conventional filter systems may be employed for purposes of filtering the waste water.

The clarifier of the invention is designed to promote and continue the separation of solids from the liquid. A very substantial portion of the solids will settle at the bottom of the clarifier tank 32 in the form of a sludge. The lighter solids will continue to float to the surface as a scum. The solids which have settled at the base of the tank 32 are then conveyed to a screw press 34 or similar concentrator of the solids for purposes of removing additional entrained water. Thereafter, the solids exiting the screw press can be introduced into the solids storage 26. The water from the screw press 34 can be removed and drained back to the clarifier 28 through a return line 36.

If desired, the water from the clarifier 28 and any solids entrained therein can be delivered to a second clarifier, as hereinafter described, connected in series with the first clarifier for further removal and separation of solids from the liquid stream. For that matter, any number of clarifying stages could be used.

Effluent overflow from the clarifier 28 is then introduced into the liquid treatment sub-system 12 through a liquid delivery line 38. If desired, the liquid treatment station 12 could also employ that second clarifier section 40 which again is designed to separate liquid from the solids. In this case, the solids would be returned in a sludge line 42 back to the clarifier 28 and the liquid would be allowed to pass into a filtration station 44, all in the manner as best shown in FIG. 1.

A coagulating agent or “coagulant”, such as aluminum sulfate, can be added at the mixer 30 or other location prior to or including the clarifier 40. Any suitable metal salt can be used in place of the aluminum sulfate, so long as that salt functions as a coagulant. The aluminum sulfate, or other coagulant, reacts with the phosphorus in the animal waste and, particularly, the phosphorus entrained in the water stream and further causes precipitation of aluminum phosphate. In this way, both the solid content and the aluminum phosphate will precipitate to the bottom of the clarifier tank and form a mass or bed of the waste material.

In effect, any metal salt in which the anion will be readily displaced by phosphorus contained in the water may be used. In the case of aluminum sulfate, the phosphorus has a strong affinity for the aluminum and will thereby displace the sulfate cation and cause a precipitation of aluminum phosphate. Other metal hydroxides may also be used. Thus, for example, a magnesium salt, e.g., magnesium salt or a magnesium hydroxide, can also be used to allow the phosphorus to create a precipitatable magnesium phosphate. Various iron salts and hydroxides can also be used.

The water which has been filtered can then be used as a backwash water for the clarifier 28 and carried in a water line 46 to be reintroduced into the clarifier. In like manner, the water from the filtration station 44 may also be passed through a disinfecting station 48 where it can then be disinfected and reintroduced into the source of water 22 or, otherwise, used for other utilitarian purposes. Any suitable disinfecting station can be used. Thus, any of a number of commercially available disinfectants can be added to the water in order to deplete bacteria count and the like.

The water from the filtration station 44 in the liquid treatment sub-system 12 can then be introduced into a pond or like storage area 50 contained in the processing station 14. In this way, the water exiting the filtration station 44 will thereupon serve as irrigation water. This also allows for nitrogen and organic material processing as hereinafter described. The disinfectant which is added at the disinfection station 48 causes very low pathogen levels in the water which makes this water suitable for reuse, such as in wash water, cooling water, flushing water and the like. Furthermore, and inasmuch as the phosphorus level in the water has been significantly reduced, there will be a substantially reduced accumulation of struvite in flush lines which are frequently used in animal farming facilities. In addition, since the phosphorus level has been reduced, operators who are not interested in crop growing will use up the phosphorus as a nutrient.

Control of the amount of phosphorus which is contained in many animal wastes is absolutely necessary since phosphorus levels greater than the phosphorus used for the crops on the land will build up in the soil and subsequently kill plant growth. Moreover, runoff from precipitation, etc. will cause the phosphorus to migrate into surface waters creating a phosphorus pollution problem. In accordance with the system of the present invention, the water which still contains some content of phosphorus can be held in the pond 50 and the waters dispersed to an adjacent area, such as land area 52 around the pond, where the applied water will not exceed the ability of the water to infiltrate the soil media and can be used for plant growth including grass.

The land area adjacent to the pond, namely that land area 52, is frequently referred to as the nitrogen and organic processing area (NOPA). The NOPA land area may be a relatively small plot of land compared to that land used in animal operations where many acres of land are used to manage waste generated in the animal operations. In this case, the NOPA land area is an important component in the system of the invention for providing a zero waste discharge allowing the waste stream to be converted to usable products and resources.

The treated water which has been disinfected at the station 48 and introduced into the pond 50 may be retained for use in a growing season. In this way, the water in the pond may be sprayed or applied to adjacent areas at an application rate of 0.25 inches (6 mm) per day to about 2.0 inches (50 mm) per day, depending upon the capability of the soil involved. This soil is also used to promote the growth of a macrobiological culture which converts ammonium, nitrates and nitrites to nitrogen gas and some of the other organics to carbon dioxide and water. Further, when the treated water from the pond 50 is applied to the adjacent areas, some of the ammonia in the water volatalizes to nitrogen gas and/or converts to ammonium and the latter of which is readily absorbed in the soil. When the NOPA land area adjacent to the pond 50 is graded at a slope of from one degree to ten degrees back toward the pond, the nitrates which have been solublized in the water percolating through the soil will drain back into the pond. In this way, the remaining nitrates will be accumulated in the pond during the non-growing season. Further, the pond remains an anaerobic environment since no air is added to the pond and this detrification or conversion of nitrates to nitrogen gas will proceed.

In many cases, animal farmers are required to maintain a minimum land area for displacement of the water used in animal waste treatment operations. This is due to the fact that water dispersal can only be applied based on the concentration of nutrients and, particularly, phosphorus. A highly loaded phosphorus content would result in destruction of plant growth.

However, it has been found in the present invention that the animal farmer is only required to maintain roughly ten to thirty percent of the normal land area requirement in order to disperse all of the necessary water. The phosphorus has been separated from the water component and the waste to a sufficient content so that only the nitrogen is managed through the NOPA land area.

The solids which have been moved to the solid storage 26 are effective for use in a variety of applications. Due to the fact that a substantial portion of the phosphorus and some of the nitrogen which has been removed from the waste is contained in recovered solids, these solids can be used as a substitute for fertilizer. In addition, the growth of grass crop can be added to the solids as a further nitrogen source to thereby augment the value of the recovered solids.

It can be seen that the process of the invention provides a zero discharge of wastes resulting from animal care. Moreover, this process provides for recovered water with low pathogen levels and low phosphorus levels where the water can be safely reused. Further, the use of natural soil conditions and facilitates macrobiological activity in the recovered water and permits conversion of ammonia into inert nitrogen gas. The process also provides for a high nutrient based solid material which can be transported as a dry material.

The invention which processes the animal waste does so in such manner that it allows this process to be environmentally friendly with natural processes. Thus, the water and solids which are created are compatible with the microbiological activity in the soils of certain areas to reduce and possibly eliminate organics and nitrogens from the waters applied to those areas. The invention is frequently referred to as a “zero discharge system” inasmuch as there is little or no discharge of components in the animal waste which are not capable of being reused. In essence, the system is designed so that the solids and the liquid are effectively and fully processed and reused.

Thus, there has been illustrated and described a unique and novel animal waste treatment system and method which allows for recovery of clean water and nutrient rich solids through the use of engineered physical and chemical processes as well as natural processes. The invention thereby fulfills all of the objects and advantages which have been sought. It should be understood that many changes, modifications, variations and other uses and applications will become apparent to those skilled in the art after considering this specification and the accompanying drawings. Therefore, any and all such changes, modifications, variations and other uses and applications which do not depart from the spirit and scope of the invention are deemed to be covered by the invention.

Having thus described the invention, what we desire to claim and secure by Letters Patent is:

1. A waste treatment system for treating solids entrained water and waste solids having water soluble portions therein and which allows for recovery of the water and the solids so that each can serve other functions, said system comprising:
a) a solids concentrator stage in which water carrying the waste solids is separated from the solids allowing the solids with substantial water removed therefrom to be collected and allowing the water to be separately collected;
b) means associated with said concentrator stage for causing removal from the solids one or more constituents in the solids which could preclude the use thereof if present;
c) a liquid treatment stage receiving the collected water and further treating the water so that it can be used for potable water purposes; and
d) a region for storing the waste solids with a substantial portion of the water removed therefrom so that the solids can be used for other purposes, thereby enabling the water and the solids to be used and thereby avoiding the need for discarding either.

2. The waste treatment system of claim 1 further characterized in that the means associated with the concentration stage comprises:
means for adding a coagulant to the solids entrained liquid causing certain constituents in the solids to be chemically separated from the solids and which constituents would otherwise be present in an amount which would be potentially harmful for agricultural use.

3. The waste treatment system of claim 1 further characterized in that the system is used in the treatment of animal waste which contains high contents of phosphorus and nitrogen, and the means associated with the concentrator stage causes removal of certain amounts of the phosphorus and nitrogen as the constituents in the solids.

4. The waste treatment system of claim 1 further characterized in that said liquid treatment stage comprises:
a filtration stage and which allows for filtering of the water from the clarifier.

5. The waste treatment system of claim 1 further characterized in that said liquid treatment stage further comprises:
a disinfecting location which provides for the addition of a disinfectant to the water to remove certain pathogens therein.

6. The waste treatment system of claim 1 further characterized in that said system comprises:
means for delivery of water from the liquid treatment stage after treatment thereof to a pond of water allowing for dispersal of the water in the pond as irrigation water.

7. The waste treatment system of claim 6 further characterized in that certain constituents in the water may remain, and where these constituents can be converted by natural processes.

8. The waste treatment system of claim 7 further characterized in that the constituents remaining in the water are at least phosphorus and nitrogen and where at least the nitrogen can be converted to nitrogen gas, nitrous oxide, or ammonia, and water, used for irrigation purposes.

9. The waste treatment system of claim 1 further characterized in that said solids concentrator stage operates in conjunction with a screw press for removing additional water from the concentrator after the water leaves the solids concentrator.

10. The waste treatment system of claim 7 further characterized in that water treated in the filtration unit is also redelivered to the clarifier as backwash water.

11. A method for treating waste solids entrained water and waste solids having portions thereof which are water soluble, said method comprising:
a) initially separating water carrying the waste solids from the solids so that the solids can be collected and so that the water can be separately collected;
b) causing a removal from the solids of one or more constituents which may be in the solids and which could preclude the use thereof if present;
c) treating the water separated from the solids so that it can be used for potable water purposes; and
d) storing the solids so that the solids can be used for other purposes, thereby enabling the water and the solids to be used and thereby avoiding the need for discarding either.

12. The method of claim 11 further characterized in that said method comprises:
adding a coagulant to the solids entrained liquid causing certain constituents in the solids to be chemically separated from the solids and which constituents would otherwise be present in an amount which would be potentially harmful for agricultural use.

13. The method of claim 11 further characterized in that the method comprises:
treatment of animal waste which contains high contents of phosphorus and nitrogen, and causing removal of certain amounts of the phosphorus and nitrogen constituents in the solids.

14. The method of claim 11 further characterized in that said step of treating the water comprises:
filtering of the water from the concentrator.

15. The method of claim 14 further characterized in that said method comprises:
adding a disinfectant to the water to remove certain pathogens therein.

16. The method of claim 14 further characterized in that said method comprises:
delivering water after treatment thereof to a pond of water allowing for dispersal of the water contained in the pond as irrigation water.

17. The method of claim 16 further characterized in that certain constituents in the water may remain, and where these constituents can be converted by natural processes.

18. The method of claim 17 further characterized in that the constituents remaining in the water are at least phosphorus and nitrogen and where at least the nitrogen can be converted to nitrogen gas, nitrous oxide or ammonia, and water, used for irrigation purposes.

19. A method for treating animal waste which is transported in a stream of water and which has certain ingredients in percentages in the water or the transported solids which would otherwise interfere with agricultural use thereof, said method comprising:
a) allowing a portion of said ingredients to be separated from solids in the waste and absorbed by or physically carried in the stream of water thereby reducing the content of such ingredients in the solids;
b) concentrating said solids and further removing such ingredients from the solids during the concentrating thereof such that the content of the ingredients is reduced sufficiently so that the solids can be fully used for agricultural purposes; and
c) further treating the water contained in the stream where any remaining ingredient content can be further reduced; and
d) delivering the water to a site where it can be exposed to the natural atmosphere and still further reducing the ingredient content sufficiently so that the water can be fully used for potable water purposes and without any of the animal waste or water being discarded.

20. The method for treating animal waste of claim 19 further characterized in that said method comprises:
further treating the concentrated solids for removal of additional water carried thereby and so that the solids become still further concentrated.

21. The method for treating animal waste of claim 19 further characterized in that the step of further treating the water comprises:
filtering the water in a filtration process before delivery to the site where it is exposed to the natural atmosphere.

22. The method for treating animal waste of claim 21 further characterized in that a disinfectant is added to the water after filtration and prior to the delivery to the site where it can be exposed to the natural atmosphere.

23. The method for treating animal waste of claim 21 further characterized in that the method comprises:
allocating certain of the water from the filtered water and reusing that filtered water as back-wash water in the step of concentrating the solids.

24. The method for treating animal waste of claim 19 further characterized in that the ingredients are phosphorus and nitrogen and that the amount of phosphorus content is reduced both in the step of allowing the ingredients to be separated from the solids and also converting the nitrogen to other forms of nitrogen where the latter can be dissipated to the atmosphere.

25. A system for treating animal waste transported in a stream of water and having certain ingredients and percentages thereof in the water or the transported solids which would interfere with agricultural use thereof, said system comprising:
a) means for thoroughly mixing the solids carrying water stream with the solids and allowing certain percentage of the ingredients in the solids to be dissolved in the water thereby initially reducing the content of the ingredients in the solids;
b) a concentrator for concentrating the solids and causing further reduction of the content of those ingredients in the solid to a level where the solids can be used for agricultural purposes; and
c) clarification means and filtration means further used for treating the water such that the concentration of the remaining ingredients is further reduced.

26. The system of claim 25 further characterized in that the system comprises:
means for adding a disinfectant to the water.

27. The system of claim 25 further characterized in that the system comprises a delivery means for delivery of the water which has been filtered and provided with a disinfectant to a storage pond where the ingredients can be converted into another form for dispersal thereof.
